(19) United States
(12) Patent Application Publication
(10) Pub. No.: US 2018/0354849 A1
(43) Pub. Date: Dec. 13, 2018

(54) HIGH-PERFORMANCE CONCRETE COMPRISING AEROGEL PELLETS

(71) Applicants: DEUTSCHES ZENTRUM FÜR LUFT-UND RAUMFAHRT E.V., Köln (DE); UNIVERSITÄT DUISBURG-ESSEN, Essen (DE)

(72) Inventors: Barbara MILOW, Hürth (DE); Lorenz RATKE, Sankt Augustin (DE); Torsten WELSCH, Hennef (DE); Silvia FICKLER, Gelsenkirchen (DE); Martina SCHNELLENBACH-HELD, Essen (DE); Jan-Eric HABERSAAT, Dortmund (DE)

(73) Assignees: DEUTSCHES ZENTRUM FÜR LUFT-UND RAUMFAHRT E.V., Köln (DE); UNIVERSITÄT DUISBURG-ESSEN, Essen (DE)

(21) Appl. No.: 15/580,495

(22) PCT Filed: Jun. 13, 2016
(86) PCT No.: PCT/EP2016/063439

§ 371 Date: Dec. 7, 2017

(30) Foreign Application Priority Data
Jun. 15, 2015 (DE) 102015210921.6

(51) Int. Cl. C04B 14/30; C04B 14/06; C04B 24/26; C04B 28/04; C04B 40/00

(52) U.S. Cl. CPC C04B 14/302; C04B 14/062; C04B 2103/32; C04B 28/04; C04B 40/0028; C04B 24/2647

(57) ABSTRACT

The invention provides an aerogel-concrete mixture, a high-performance aerogel concrete obtained therefrom, and a method for production thereof. The problem addressed by the present application is that of providing pressure-resistant but not very thermally conductive concretes, precast concrete components, screeds, screeds for precast components, (glassfibre-) reinforced concrete, fire protection panels, construction elements for thermal partition and blocks. The aerogel-concrete mixture contains: 10% to 85% by volume/m³ of aerogel pellets having a grain size in the range from 0.01 to 4 mm, 100 to 900 kg/m³ of inorganic hydraulic binder, 10% to 40% by weight based on the binder content of at least one silica gel suspension, 1% to 5% by weight based on the binder content of at least one plasticizer, 0.2% to 1% by weight based on the binder content of at least one stabilizer and 0% to 60% by volume/m³ of at least one lightweight aggregate.

### FIELD OF THE INVENTION

The invention relates to an aerogel concrete mixture, a high performance aerogel concrete obtained therefrom, and a process for preparing it.

### BACKGROUND OF THE INVENTION

The requirements for the thermal insulation of residential and non-residential buildings have resulted in a wide variety of further developments in the field of building materials for massive outer walls since the beginning of the millennium. If the requirements for the heat transition coefficient (such as the U value in EnEv2014 (German Federal Ministry of Justice and for Consumer Protection. Second Order Amending the Energy Saving Regulations. Federal Law Gazette Issue 2013 Part I No. 67. Bonn; Nov. 21, 2013)) as formulated in the national regulations and resulting from the EU Directive on the Energy Performance of Buildings (The European Parliament and the Council of the European Union. Directive 2010/31/EU on the energy performance of buildings. Official Journal of the European Union L 153/13; Jun. 18, 2010) are to be met by one-shell constructions, this is usually possible only by the use of masonry blocks with a low bulk density and thus with a low compressive strength. The thermal conductivities of heat insulating masonry are within a range of from λ=0.06 W/(m·K) to λ=0.16 W/(m·K) (Table 1, lines 1 to 6), so that a wall thickness of from 36.5 cm to 49 cm is usually required to meet the demanded U values.

TABLE 1
Bulk densities, thermal conductivities and compressive strengths of selected massive
wall building materials

| | | | fₖ or f_{(l)ck} | λ | P [10⁻³ · |
|---|---|---|---|---|---|
| | Material | ρ (kg/m³) | (MPa) | (W/(m · K)) | MNm²K/Wkg] |
| 1 | Lightweight concrete block Bisomark | 315-335 | 0.8 | 0.06 | 42.3 |
| | Hbn* | | | | |
| 2 | Autoclaved aerated concrete Ytong PP | 250 | 0.8 | 0.07 | 45.7 |
| | 1.6-0.25** | | | | |
| 3 | Poroton bricks S9-MW*** | 810-900 | 4.2 | 0.09 | 57.6 |
| 4 | Autoclaved aerated concrete Ytong PP | 400 | 1.8 | 0.10 | 45.0 |
| | 2-0.40** | | | | |
| 5 | Lightweight concrete block Bisoplan | 600 | 2.5 | 0.14 | 29.8 |
| | 14* | | | | |
| 6 | Poroton planar bricks T16*** | 710-800 | 4.7 | 0.16 | 41.4 |
| 7 | Sand-lime bricks Silka KS L-R P 12- | 1210-1400 | 5.6 | 0.56-0.70 | 8.3 |
| | 1.4**** | | | | |
| 8 | Lightweight concrete LC35/38**** | 1500-1600 | 35.0 | 0.89-1.00 | 26.2 |
| 9 | Sand-lime bricks Silka KS-R P 20-2.0**** | 1810-2000 | 10.5 | 0.99-1.10 | 5.9 |
| 10 | Normal concrete C12/15***** | 2200-2400 | 12.0 | 1.65-2.0 | 3.3 |
| 11 | Reinforced concrete C30/37***** | 2300-2400 | 30.0 | 2.3-2.5 | 5.7 |

*Bisotherm GmbH. Mauerwerk-Komplett-Programm Bauen, Mülheim-Karlich, Germany; 2013.
**Xella Deutschland GmbH. Product program 2015. Duisburg, Germany; 2015.
***Wienerberger GmbH. Price list 2014 Poroton brick systems. Hanover; 2014.
****DIN 4108-4: 2013-02 Thermal insulation and energy economy in buildings - Part 4: Hygrothermal design values. Berlin: Beuth Verlag; 2013.
*****ISO 10456: 2010-05 Building materials and products - Hygrothermal properties - Tabulated design values and procedures for determining declared and design thermal values. Berlin: Beuth Verlag; 2010.

The performance stated in Table 1 is defined as the ratio of compressive strength f in [MN/m²] to the product of bulk density ρ in [kg/dm³] and thermal conductivity λ in [W/mK].

As can be seen from Table 1, the compressive strengths of these building materials optimized for a low thermal conductivity are within a range of fk≤4.7 MPa. Therefore, despite the large wall thickness, these building materials can be usually used only for buildings with a low number of storeys. If higher compressive strengths are required, a one-shell outer wall construction without a further heat insulation usually cannot be realized any longer because of the higher bulk densities and the accompanying higher thermal conductivities (Table 1, lines 7 to 11). In this case, supporting shells of normal concrete, lightweight concrete or sand-lime bricks are mostly embodied with a thermal insulation composite system or with a core insulation and lining shell (two-shell walls).

The idea of embedding aerogel granules into a cement matrix was first reported in Ratke L., Herstellung und Eigenschaften eines neuen Leichtbetons: Aerogelbeton. Beton- und Stahlbetonbau 103 (2008) Issue 4, pp. 236 to 243. Predominantly, superhydrophobic silica-aerogel granules with a particle size of from 0.01 to 4.0 mm, a porosity of >90%, and a particle bulk density of 120 to 150 kg/m³ were used, which were added to normal strength mixtures of CEM II 32,5 R, CEM I 42,5 R and CEM I 52,5 R. The aerogel proportion was varied between 50% by volume and 75% by volume, so that aerogel concretes having densities of 580 kg/m³≤ρ≤1,050 kg/m³ were prepared. The results of the experiments show the excellent physical properties of this construction material. For a uniform distribution of 70% by volume aerogel granules, a thermal conductivity of λ=0.10 W/(m·K) was measured. Thus, the aerogel concrete has a thermal conductivity comparable to that of heat insulation masonry (Table 1, lines 1 to 6). The mean compressive strengths determined for prisms having edge lengths of 40 mm were within a range of 0.6≤f_{cm,prism40}≤1.5 MPa and thus clearly below the compressive strengths of the wall building materials listed in Table 1. The moduli of elasticity derived from the results of the compressive strength tests were from 52 MPa to 127 MPa. The performance of the aerogel concretes according to the invention was preferably 9.3·10⁻³ MNm²K/Wkg. In the calculation, the prism strength f_{cm,prism40} was converted to the cube compressive strength (150 mm edge length), f_{cm}, with a factor of 0.9.

From DE 10 2006 033 061 A1, especially from Example 1 in combination with paragraph [0036], an aerogel concrete mixture can be seen that contains Aerosil®, Portland cement, a dispersing agent in the form of a silica gel suspension, a concrete plasticizer, and a lightweight aggregate in the form of Superlite®.

In Hub A., Zimmermann G., Knippers J., Leichtbeton mit Aerogelen als Konstruktion-swerkstoff. Beton- and Stahlbetonbau 108 (2013) Issue 9, pp. 654 to 661, silica aerogel granules were embedded into an unspecified matrix of ultra high performance concrete (UHPC) in order to improve the compressive strength of aerogel concrete. The measured thermal conductivities were from λ=0.06 W/(m·K) for mixtures with a bulk density of ρ≤400 kg/m³ to λ=0.10 W/(m·K) for mixtures with a bulk density of ρ=570 kg/m³. The compressive strength for mixtures within a range of 500 kg/m³≤ρ≤620 kg/m³ was determined to be 1.4≤f_{cm,prism40}≤2.5 MPa, so that the intended positive effect of the UHPC matrix on the compressive strength can be observed in principle. The compressive strength of the aerogel concrete with ρ≤400 kg/m³ was not examined. The further results of the examinations in Hub et al. show that aerogel concrete has a low modulus of elasticity (E_{cm}=1100 MPa), a high frost resistance, a low coefficient of thermal expansion (5.3×10⁻⁶ K⁻¹), a high tendency to shrink (2.2 mm/m), and a very low bond stress (0.95 N/mm² for a slip of 0.02 mm for reinforced concrete of 8 mm Ø). The performance of the examined UHPC-based aerogel concretes was around 25.2·10⁻³ MNm²K/Wkg.

The compressive strength, flexural strength and thermal conductivity of aerogel concrete were also examined in Gao T., Jelle B. P., Gustaysen A., Jacobsen S., Aerogel-incorporated concrete: An experimental study. Construction and Building Materials 52 (2014), pp. 130-136. Hydrophobized aerogel granules with a grain size of 2 to 4 mm, CEM I 52,5 R, silica fume, plasticizer, sand and distilled water were used for the examined mixtures. The water-to-binder ratio was set to 0.4, the volume of the aggregates (aerogel and sand) was set to 60% by volume. The aerogel proportion varied from 0 to 60% by volume, which resulted in bulk densities within a range of from 1,000 kg/m³ to 2,300 kg/m³. For the most interesting mixture with an aerogel proportion of 60% by volume, the results were λ=0.26 W/(m·K), f_{cm,prism40}=8.3 MPa, and f_{c,fl}=1.2 MPa. Mathematical relations for the relationships between the thermal conductivity and density, and between the compressive strength and density, were derived. The performance of the aerogel concretes according to the invention was preferably from 13.9·10⁻³ to 28.7·10⁻³ MNm²K/Wkg.

Ng S., Jelle B. P., Sandberg L. I. C., Gao T., Wallevik O. H., Experimental investigations of aerogel-incorporated ultra-high performance concrete. Construction and Building Materials 77 (2015), pp. 307-316, reports about further optimizations of aerogel concrete. Here, from 20 to 80% by volume of aerogel granules was embedded into a UHPC mixture, in which an aerogel proportion of 50% by volume is considered optimal. For this mixture, a bulk density of 1,350 kg/m³, a compressive strength of f_{cm,prism40}=20 MPa, and a thermal conductivity of λ=0.55 W/(m·K) were determined. Thus, while a considerable increase of compressive strength was achieved, the thermal conductivity remained clearly above the values for aerogel concretes determined to date. An increase of the aerogel proportion to 70% by volume brought about a considerable reduction of the compressive strength by a factor of 4 (f_{cm,prism40}=5.8 MPa), but only resulted in an improvement of thermal conductivity by 20% to λ=0.44 W/(m·K). For specimens made of cement-silica mixtures prepared in parallel that were produced without the fine components typical of UHPC (sand and fine sand), considerably lower compressive strengths and thermal conductivities were observed for the same aerogel proportions. These cement-silica mixtures were prepared with an increased water-to-cement ratio of 0.60, because no plasticizers were added. The performance of the aerogel concretes according to the invention was preferably from 21.8·10⁻³ to 25.4·10⁻³ MNm²K/Wkg.

To date, aerogel concrete has shown excellent physical properties, but the low modulus of elasticity, the high tendency to shrink, the low bond stresses, and especially the compressive strength, which is still below that of brick or lightweight concrete masonry having a comparable thermal conductivity (Table 1=characteristic values), conflict with an application of aerogel concrete for supporting walls of multi-storey buildings.

### BRIEF SUMMARY OF THE INVENTION

Therefore, the object of the present invention is to provide concretes, precast concrete parts, screeds, precast screed parts, glass fiber reinforced concretes, fire protection boards, components for thermal separation, and bricks with a high compressive strength, but low thermal conductivity.

### BRIEF DESCRIPTION OF THE DRAWINGS

The present invention is illustrated and described herein with reference to the various drawings, in which like reference numbers denote like method steps and/or system components, respectively, and in which:

FIG. 1 is a temperature curve for a mixture according to the present invention;

FIG. 2 is a graph illustrating the relationship between the bulk density and compressive strength for the mixtures with mixed storage;

FIG. 3 illustrates the compressive strength of 13 mixtures of concrete aged 28 days in relation to the bulk density;

FIG. 4a illustrates a support layer of high performance concrete and an insulation layer of aerogel concrete of the present invention;

FIG. 4b illustrates an insulation layer, support layer, and insulation layer of the present invention;

FIG. 5a illustrates the thermal separation in stell-reinforced concrete ceilings;

FIG. 5b is a cross-section of FIG. 5a;

FIG. 5c is an exemplary embodiment illustrating pressure bearing of high performance aerogel concerete within the heat insulation XPS or mineral fiber;

FIG. 5d illustrates reinforcement in the insulating element of high performance aerogel concrete; and

FIG. 5e illustrates a wall or support with high thermal conductivity and supporting insulating brick of high performance aerogel concrete.

### DETAILED DESCRIPTION OF THE INVENTION

In a first embodiment, the above object is achieved by an aerogel concrete mixture containing:

from 10 to 85%, especially 75%, by volume/m³ of aerogel granules having a grain size within a range of from 0.01 to 4 mm,

from 100, especially from 200 to 900, kg/m³ of inorganic hydraulic binder,

from 10, especially from 20 to 40%, by weight, based on the content of binder, of at least one silica gel suspension,

from 1, especially from 2 to 5%, by weight, based on the content of binder, of at least one plasticizer,

from 0.2 to 1% by weight, based on the content of binder, of at least one stabilizer, and

from 0, especially from 10 to 60%, by volume/m³ of at least one lightweight aggregate, for example, lightweight sands, expandable clay, and/or expandable glass.

According to the invention, high performance concretes become obtainable in which an “aerogel concrete” that combines the advantages of conventional concretes (high compressive strength, unlimited formability) with the properties of a heat-insulating material is developed by embedding aerogel granules into a high strength cement matrix. Thus, the core of the invention is the development of a building material that exceeds the compressive strengths of conventional heat insulation masonry with comparable thermal conductivities, and is thus suitable for preparing one-shell outer walls of multistorey buildings without further thermal insulation.

Mixtures for aerogel concretes are prepared on the basis of mixing compositions for high performance concrete (HPC), ultra high performance concrete (UHPC), and lightweight concrete (LC). The aerogel concrete according to the invention has extraordinary thermal insulation properties, and a compressive strength comparable to that of normal concrete. The excellent thermal insulation properties are achieved by the use of aerogel granules in an amount of from 10 to 85% by volume, preferably 70% by volume, per m³, especially from 60 to 65%, preferably from 50 to 70%, by volume per m³. The grain size of the aerogel is from 0.01 to 4 mm, especially from 1 to 4 mm. This grain size can be obtained by simple sieving. This removes fines, especially dust. The presence of these fines results in a deterioration of the compressive strength values.

In DE 10 2006 033 061 A1, sand is added to the mixture, as it is usually the case in the mixing of concretes and mortars. However, according to the invention, sand and coarse aggregates are preferably dispensed with completely (except mixtures with additional lightweight aggregates).

The combination of the individual components of the aerogel concrete according to the invention is effected with consideration of the known mixing compositions for HPC, UHPC, and LC. The examined components are listed below:
Portland cement,
microsilica (dust and suspension),
various usual aggregates,
quartz sand,
concrete plasticizer,
stabilizer,
aerogel granules,
water,
lightweight aggregates (for example, lightweight sands, expandable clay, expandable glass).

The mixtures prepared from these components that were examined are described below:

According to the invention, the influence of the above stated components was examined. Thus, 25 mixtures (prismatic specimens) were prepared with the aim of increasing the compressive strength. The concentrations of the additives, of the concrete plasticizer, or the microsilica and of the Portland cement were varied. Thereafter, the best mixtures were further optimized. For this purpose, cube specimens with an edge length of 15 cm were examined according to the German standard (EN 123903:2009-7 Testing hardened concrete—Part 3: Compressive strength of test specimens. Berlin: Beuth Verlag; 2009). The following description relates to these optimized mixtures M1 to M7.11.

Another important aspect for the development of the compressive strength of aerogel concrete is the kind of storage. Within the scope of the examinations, three different kinds of storage were considered: Dry storage as an ambient temperature of 20° C.±2° C., mixed storage according to EN 12390-2 (EN 12390-2 Ber 1: 2012-02 Testing hardened concrete—Part 2: Making and curing specimens for strength tests. Annex NA. Berlin: Beuth Verlag; 2012) for six days under water at a water temperature of 20° C.±2° C. and the subsequent 12 days in air at an ambient temperature of 20° C.±2° C. Schachinger, I. Untersuchungen an Hochleistungs-Feinkorn-Beton. 38. DAfStb-Forschungskolloquium. TU Munchen; 2000 pp. 55-66, reports about positive influences of thermal treatment on the compressive strength of HPC. Therefore, cube specimens with a concrete age of 24 h were also thermally treated in a drying cabinet for 24 h. All cubes were demolded at a concrete age of 24 h before being stored under the three different storage conditions mentioned.

Three specimens were required for each mixture and for each kind of storage. In addition, the compressive strength was each determined at a concrete age of seven and 28 days as set forth above. Therefore, a total of 18 specimens was prepared for each mixture.

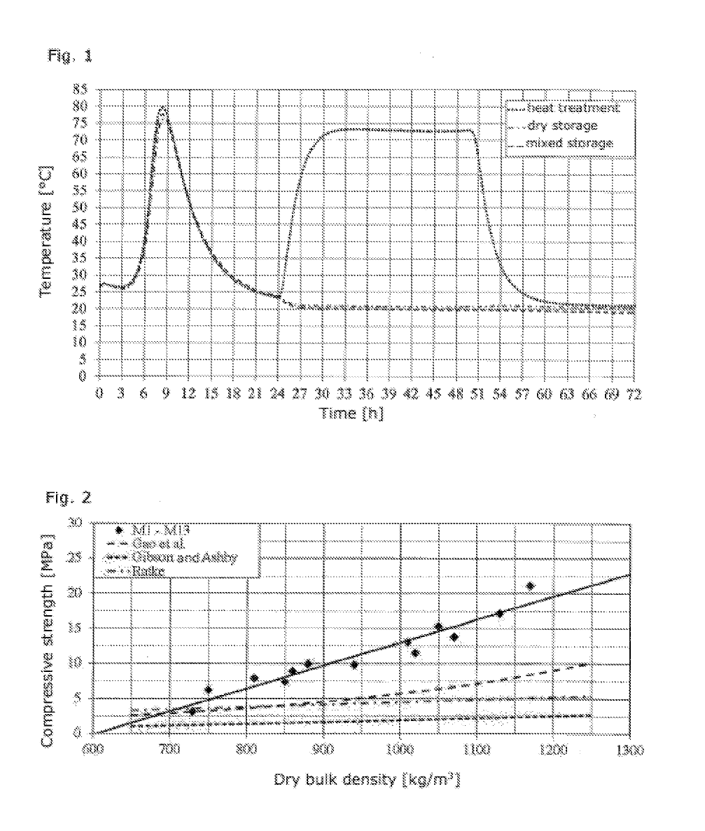

In order to determine the influence of the thermal treatment and the heat of hydration of the aerogel concrete, the temperature was measured during the hydration process by a temperature sensor encased in concrete in the core of the cubic specimen. For each mixture, three temperature measurements were performed in accordance with the three kinds of storage (FIG. 1). FIG. 1 shows the temperature curves for mixture M10. During the first few hours, a significant increase of the core temperatures could be observed. After five to eight hours, the maximum temperature was reached. The high core temperature resulted from the high cement content and the addition of silica fume (see also Held M. Hochfester Konstruktions-Leichtbeton. Beton 1996; 7: 411 to 415). The three temperature curves do not drop as much as they rise. Independently of the maximum temperature, the core temperature for mixtures M1 to M13 was from 20° C. to 25° C. after 26 h. During this period, the air and water temperatures were maintained between 20° C. and 25° C. Therefore, it is to be considered that the hydration process was concluded after 26 h.

The thermal treatment of the cubic specimens is also represented in FIG. 1. The drying cabinet had an ambient temperature from 84° C. to 93° C. The core temperature of the concrete cubes reached a maximum value of 80° C. and essentially depends on the high cement proportion and the silica proportion. The influence of the selected thermal treatment on the compressive strength is low.

The results of the compressive strength examinations and the related bulk densities are listed in Table 2.

TABLE 2
Mixture compositions, compressive strengths after 28 days (7 days), thermal conductivities and performance of the optimized mixtures

| | Mixture | | | | | | | | | |
|---|---|---|---|---|---|---|---|---|---|---|
| | M7.10 | M7.8 | M1 | M10 | M9 | M7.7 | M2 | M7.5 | M7.3 | M7.1 |
| Aerogel content φ | 77 | 70 | 60 | 60 | 60 | 65 | 60 | 60 | 55 | 45 |
| [% by volume] | | | | | | | | | | |
| CEM I 52.5 R | 202.0 | 348.9 | 500.8 | 534.6 | 502.8 | 473.0 | 541.7 | 559.5 | 647.5 | 846.2 |
| [kg/m³] | | | | | | | | | | |
| Microsilica powder/ | 60.6 | 104.7 | 65.1 | 139.0 | 66.2 | 141.9 | 140.8 | 167.8 | 194.3 | 253.9 |
| suspension [kg/m³] | | | | | | | | | | |
| Plasticizer [kg/m³] | 9.1 | 15.7 | 19.0 | 19.0 | 19.3 | 21.3 | 19.0 | 25.2 | 29.1 | 38.1 |
| Stabilizer [kg/m³] | 1.0 | 1.7 | — | 2.7 | 2.5 | 2.4 | — | 2.8 | 3.2 | 4.2 |
| Water [kg/m³] | 80.8 | 94.2 | 204.1 | 97.9 | 190.5 | 71.0 | 97.0 | 69.9 | 68.0 | 50.8 |
| Dry bulk density ρ | 487 | 690 | 850 | 860 | 880 | 888 | 1015 | 1133 | 1326 | 1450 |
| [kg/m³] | | | | | | | | | | |
| Dry storage: f_{cm} | — | — | 7.4 | 8.9 | 9.9 | — | 11.5 | — | — | — |
| [MPa] | | | | | | | | | | |
| Thermal treatment: | — | — | 7.8 | 10.0 | 9.5 | — | 12.7 | — | — | — |
| f_{cm} [MPa] | | | | | | | | | | |
| Mixed storage: f_{cm} | 1.4 | 4.8 | 8.4 | 9.3 | 9.2 | 5.94 | 13.9 | 16.8 | 26.0 | 24.7 |
| [MPa] | | | | | | | | | | |
| Mixed storage: f_{cm, 7} | 1.3 | 4.3 | 8.1 | 8.9 | 6.6 | 7.07 | 10.3 | 16.4 | 27.4 | 27.2 |
| [MPa] | | | | | | | | | | |
| Thermal conductivity | 0.082*) | 0.137*) | — | 0.168**) | 0.188**) | 0.199**) | — | 0.191*) | 0.255*) | — |
| λ [W/mK] | | | | | | | | | | |
| Performance P | 35.1 | 50.8 | — | 64.4 | 55.6 | 33.6 | — | 77.6 | 76.9 | — |
| [10³ · MNm²K/Wkg] | | | | | | | | | | |

*)HFM method
**)THB method

The stated compressive strengths f_{cm} are defined as the mean compressive strength of cubic specimens with 150 mm edge length after 28 days, f_{cm,7} are defined as the mean compressive strength of cubic specimens with 150 mm edge length after 7 days.

Most mixtures achieved the highest compressive strength upon mixed storage. The early thermal treatment did not lead to significantly higher compressive strengths. No clear trend could be observed in view of the compressive strengths after seven and 28 days.

A comparison between the values stated in Table 2 with the values from the prior art (Table 1 and p. 4 to p. 7) shows clearly that the performance of the high performance aerogel concretes according to the invention is in part considerably higher than that of the known lightweight building materials and aerogel concretes. A “high performance aerogel concrete” within the meaning of the invention means an aerogel concrete that has a performance of at least 30.0·10⁻³ MNm²K/Wkg.

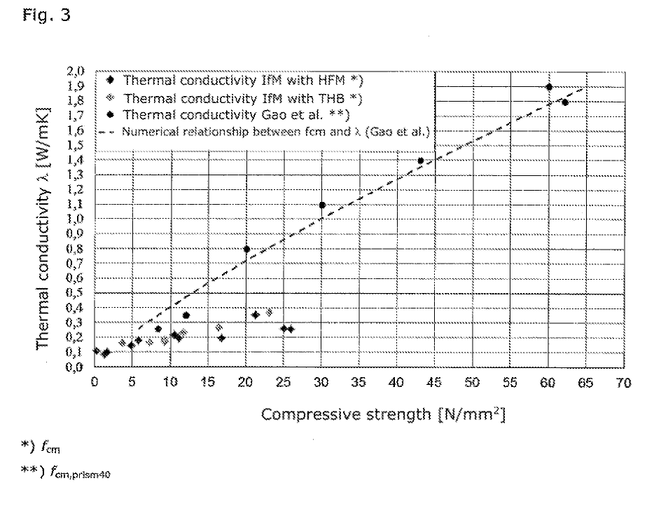

The relationship between the bulk density and compressive strength is plotted in FIG. 2 for 13 mixtures with mixed storage. For this purpose, a linear regression analysis was performed. The coefficient of determination was calculated to be 0.93, which shows a high correlation between the bulk density and compressive strength. According to Gibson L. J., Ashby M. F. Cellular solids. Cambridge University Press. 2nd Edition. Cambridge; 1997; p. 213, the compressive strength of porous bodies can be calculated as a function of the bulk density. Here, the values of the Portland cement employed were substituted for ρ₀ and a σ_{cr}⁰.

σ_{cr}=0.2·σ_{cr}⁰·(ρ/ρ₀)^{(3/2)} Equation (1)

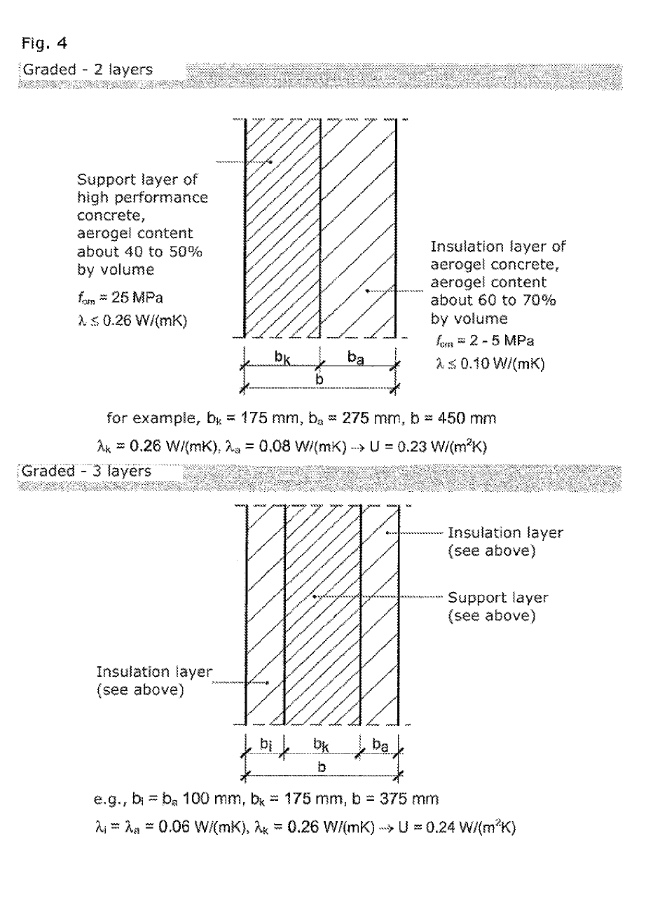

Taking into account the studies on aerogel concrete from Ratke (supra), the exponent 3/2 in this equation should be replaced by ¾. Both functions are represented in FIG. 2. In the experimental studies performed by the Institut für Massivbau (IfM), most optimized mixtures reached higher compressive strengths than was to be expected on the basis of Equation (1) according to Ratke (supra) and Gao et al. (supra). FIG. 3 shows the compressive strength of 13 mixtures at a concrete age of 28 days in relation to the bulk density.

The thermal conductivity of some mixtures (see Table 2) was determined by the “transient hot bridge” (THB) measuring method or by using the “heat flow meter” (HFM). The results of the IfM and of Gao et al. (supra) are shown in FIG. 3. A correlation between the compressive strength and thermal conductivity is clearly visible. In both studies, the thermal conductivity increases as the compressive strength (and bulk density) increases. The experimental results from Gao et al. (supra) are from 8 MPa to 62 MPa with related thermal conductivities of from 0.26 W/(m·K) to 1,9 W/(m·K), while the compressive strengths and thermal conductivities determined according to the invention are from 1.4 MPa to 26 MPa and from 0.082 W/(m·K) to 0.255 W/(m·K), respectively.

This means that smaller values for the thermal conductivity and thus better heat insulation properties were determined for comparable compressive strengths within the scope of the present invention. FIG. 3 shows the relationship between the compressive strength and thermal conductivity.

Based on the known formulations for HPC, UHPC and LC, an aerogel concrete with an enhanced compressive strength was obtained according to the invention while good heat insulation properties were maintained.

The compressive strength correlated with the bulk density and reached values as high as 26.0 MPa. In view of the compressive strengths after 7 and after 28 days, no clear trend could be observed. The thermal conductivities were determined as 0.082≤λ≤0.255 W/(m·K), which means good heat insulation properties.

As compared to heat insulation masonry, the high performance aerogel concrete according to the invention has higher compressive strengths with comparable thermal conductivities.

Another embodiment of the invention is a process for preparing aerogel concretes using the mixture described above with water. In this process, the order of mixing is of particular importance.

Mixtures for high performance (HPC) and ultrahigh performance concretes (UHPC) are usually prepared as described in Bundesverband der deutschen Zementindustrie, Zement-Merkblatt Betontechnik B 16 10.2002, Hochfester Beton/Hochleistungsbeton, Leipzig 2002:

“In order to achieve optimum homogenization of the ultrafine materials, in particular, the following metering order has proven useful: aggregates, cement, water and subsequently fly ash and silica fume suspension. For an optimum effect of the additives, the latter should be metered after the addition of the water and silica fume.” Mixtures prepared in this way have only low compressive strengths and performances, as demonstrated by the state of the research and our own studies.

As compared to this order of mixing, which is familiar to the skilled person, the mixing procedure was changed in the process according to the invention, preferably as follows: Premixes of the liquid components are prepared in advance. Thus, ⅓ of the added water is mixed with the plasticizer, and ¼ of the added water is mixed with the silica suspension. Thereafter, the aerosol granules and, if any, the lightweight aggregates are mixed together. After a mixing time of about 30 to 60 seconds, the water-silicate mixture is added. After another 30-60 seconds mixing time, the water-plasticizer mixture and the stabilizer are added to the mixture. Thereafter, the mixing process is to be stopped for the inorganic binder to be filled into the mixer. After another 1-2 minutes mixing, the metering containers for the silica suspension and the plasticizer are filled each with 50% by volume of the remaining added water, flushed with it, and discharged into the mixer. The entire mixture is mixed for another 2-10 minutes before it can be processed. The mixtures prepared in this way surprisingly showed a considerably higher compressive strength and performance as compared to the use of conventional mixing procedures (see Table 2).

The added water is dosed in such a way that water-to binder (w/b) ratios of 0.15-1.00, especially 0.20 to 0.60, preferably 0.28-0.35, result. For the calculation of the w/b ratio, only the fraction of the hydraulic binder without further solid components, such as the silica, is to be used.

Particularly low w/b ratios and thus high compressive strengths are obtained if the added water is cooled before being mixed with the solid components, especially to a temperature of less than 10° C., more preferably to less than 5° C.

Silica gel suspensions within the meaning of the present invention are commercially available and include, in particular, a very reactive amorphous microsilica-water mixture with a high specific surface area, for example, MC Centrilit Fume SX: Blaine value 20,000, i.e., 4 to 5 times as high as that of cement/binder.

The silica gel may be added in powder form or as a suspension, wherein the solids content of the suspension is usually 50% by volume. This means, the silica suspension has a content of active ingredients of 50% by volume, and the other 50% by volume usually consists of water.

Plasticizers within the meaning of the present invention are commercially available and include, in particular, commercially available polycarboxylates, for example, Powerflow 3100: polycarboxylate ether with a solids content of 30% by weight, a high charge density and short side chains.

Stabilizers within the meaning of the present invention are commercially available and include, in particular, commercially available organic polymers, for example, MC Stabi 520, water-absorbing and water-incorporating cellulose.

In addition to the components mentioned above of the aerogel concrete mixture, the mixtures according to the invention may also contain further usual concrete admixtures and concrete additives.

Concrete admixtures are defined in the European Standards EN 934, “Admixtures for Concrete, Mortar and Grout”, which are binding in all CEN member states. Part 2 of EN 934 contains the definitions of and requirements for concrete admixtures:
“a material added during the mixing process of concrete in a quantity not more than 5% by mass of the cement content of the concrete, to modify the properties of the mix in the fresh and/or hardened state.”

EN 934-2 contains definitions and requirements for the following individual groups of active components:
concrete plasticizers,
superplasticizers,
stabilizers,
air-entraining agents,
accelerators: setting accelerators and hardening accelerators,
retarders, and
sealing agents.

Sand (grain bulk density ρ>2000 kg/m³) is generally not required, because it is replaced by aerogel granules or/and lightweight aggregates. “Lightweight aggregates” means lightweight aggregates or lightweight sands with a grain bulk density ρ≤2000 kg/m³.

Components of aerogel concrete prepared with the stated mixture compositions and according to the described mixing procedure are surprisingly characterized by a very short hardening time and a very fast development of strength as compared to the previously known aerogel concretes. Setting of the fresh concrete can be observed already after 15-30 minutes, and after about 26 hours, the hydration process is almost completed (see also FIG. 1), so that the compressive strength at this time is already about 80% of the compressive strength after 28 days.

The wall/ceiling elements or bricks of graded aerogel concrete according to the invention have a high load capacity and a low thermal conductivity. They thus enable the preparation of one-shell outer wall constructions of multi-storey residential and non-residential buildings without additional heat insulation as required, for example, in heat insulation composite systems (HICS) or two-shell masonry with core insulation (see above). However, additional shells means a higher expenditure of production and thus a higher cost. In addition, there are constructive issues (fire protection in EPS and XPS insulation materials, fastening technology, algae growth on the facade, recyclability of HICS).

“Graded aerogel concrete” within the meaning of the invention means that components are prepared from at least two layers of different aerogel concrete mixtures. Such components can be manufactured “fresh in fresh” or “fresh onto hard”. In the first case, the first layer of aerogel concrete is first put into place, and the second layer is produced immediately thereafter, even before the first layer has hardened. In the “fresh onto hard” method, the second layer is prepared only after the first layer has hardened. Independently of the selected method, a final product having a multilayer structure is obtained, wherein the layers are bonded together in a pressure-resistant, tension-resistant and shear-resistant way.

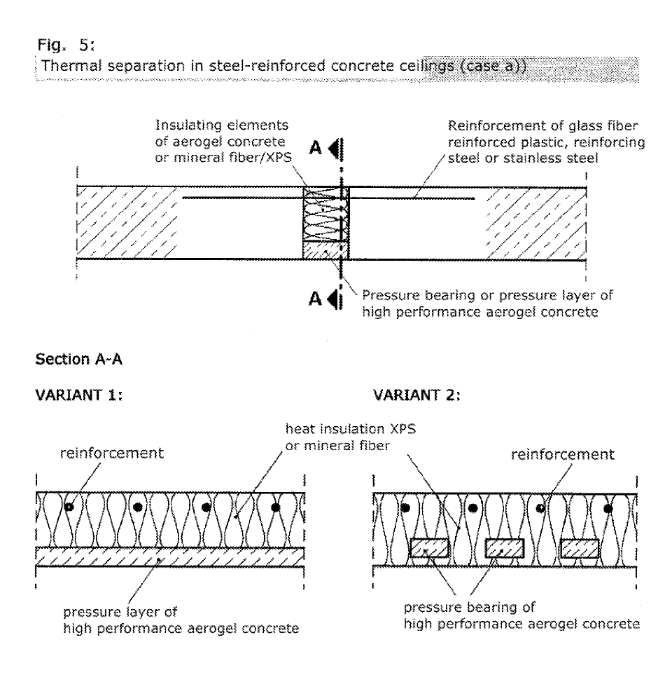

The load capacity and thermal conductivity of wall constructions and aerogel concrete could be further optimized by employing the aerogel concrete building material in this graded way (FIGS. 4a and 4b). In doing so, two approaches were used: On the one hand, the wall elements were designed in such a way that different layers of a material were arranged whose composition was selected individually for each layer (graded mono-material component). A component for one-shell walls consisting of different layers was obtained thereby, each of which primarily met the mechanical or physical requirements. On the other hand, an aerogel concrete having a significantly more favorable relation between the compressive strength and thermal conductivity as compared to conventional wall components for massive outer walls was employed as a material for these different layers. The above stated high performance aerogel concrete having a high compressive strength (f_{cm}=25 MPa), but a relatively low thermal conductivity (λ=0.25 W/(m·K)) was used for the supporting layer, while an aerogel concrete with sufficient compressive strength and a very low thermal conductivity was used for the insulation layer. In the production of prototypes according to the invention, aerogel concretes with f_{cm}=2 MPa and λ=0.09 W/(m·K) were prepared and employed for the insulation layer.

In this respect, a preferred feature of the present invention is the combination of the per se known aerogel concrete with the constructional design of a graded building material. To be delimited therefrom are functionally graded concretes in which aerogel concrete is employed exclusively as a porous filler for non-supporting regions of components.

In order to meet the demands for footfall sound insulation in building construction, so-called “floating screeds” are used. These consist of an at least 35 to 75 mm thick layer of cement, calcium sulfate, mastic asphalt, magnesia or artificial resin screed, which is provided on a compressible layer of insulation materials (EPS foam, mineral wool) having a thickness of about 20 to 50 mm. When underfloor heating is provided, the thickness of the screed layer is to be increased by the dimension of the heating tube diameter, so that screed thicknesses of more than 10 cm are to be observed in practice. The density of the screed types stated above varies from 2.0 to 3.0 kg/dm³, and consequently, the intrinsic load of the screed layers is from 0.7 kPa to about 3.0 kPa. The thermal conductivity of such screeds is from λ=0.5 W/(m·K) (magnesia screed) to λ=1.4 W/(m·K) (cement screed). Depending on the strength class, cement screeds have a high load capacity, are also suitable for wet rooms, but tend to cracking and warping and require long drying times of several weeks or months (depending on the thickness). Anhydrite screeds have significantly shorter drying times of about one week, but have a lower load capacity and are not suitable for wet rooms. Mastic asphalt screeds reach their mechanical properties immediately after cooling and are very robust, exhibit a good footfall sound insulation, but are to be evaluated unfavorably in the event of a fire (fire propagation, toxic combustion gases). Magnesia screeds are lightweight and have mechanical load capacity, but are also very moisture-sensitive. Artificial resin screeds are resistant to water and many chemicals, dry very quickly, and have a high mechanical load capacity, but are criticized for the possible emission of hazardous substances. The use of aerogel concrete as a screed has not been possible to date because of its low compressive and tensile strengths.

The aerogel screed according to the invention combines in itself the advantages of the mentioned screeds, but does not have any of the mentioned drawbacks. An important aspect of the present application is to use high performance aerogel concrete as a material for preparing a floating screed, or aerogel screed. This application of aerogel concrete as a screed has become possible only through the development of the high performance aerogel concrete according to the invention and the accompanying improvement of mechanical properties. The studies according to the invention show that a screed made of high performance aerogel concrete exhibits high compressive strengths (up to about 10 MPa), sufficient tensile strengths (about 2-3 MPa) and low thermal conductivities (λ=0.06-0.16 W/(m·K)) for low bulk densities (about 0.5-1.0 kg/dm³). The tensile strength and the shrinking and cracking performance can be improved, for example, by adding glass fibers.

Aerogel concretes dry within a few days and show a low water absorbing capacity after curing. Aerogels are not toxic, not cancerogenic, and have been classified as a “largely non-hazardous material” by the German Federal Environment Agency. Aerogel concrete is an excellent fire-protection material and exhibits a high sound absorption.

The low bulk density results in intrinsic loads of from about 0.25 kPa to about 1.0 kPa for a usual screed thickness. The reduced intrinsic load has the effect that the supporting components of a building are less loaded and therefore can be designed with smaller dimensions. Further, this results in potential applications in building redevelopment, where the screed may also be employed in the form of precast screed sheets. Because of the low weight, the low modulus of elasticity and the high sound absorption of aerogel screed within the meaning of the present invention, the compressible layer below the screed may be dispensable, so that the screed may be applied directly to the floor slabs.

However, prefabricated construction boards of high performance aerogel concrete are suitable not only as precast screed components, but also as fire-protection sheets. Inflammable components or components whose mechanical properties change under the action of high temperatures in a way relevant to structural safety must be effectively protected from fire exposure. The fire-protection sheets of aerogel concrete according to the invention are applied as a lining to the components to be protected. Because of the excellent fire-protecting properties of the material, the lined components are not only effectively protected from immediate fire exposure, but because of the extremely low thermal conductivity, the temperature on the backside of the sheet remains so low in the event of a fire that an influence on the mechanical properties of the components to be protected is excluded.

Currently employed fire-protection sheets are usually cement-bonded, glass fiber reinforced construction boards to which mineral lightweight aggregates, such as expandable clay, are added, or calcium silicate boards. Although such boards protect effectively from immediate fire exposure, they have temperatures on the backside of the boards in the event of a fire that may be damaging to particularly sensitive components, such as CFRP strips or CFRP laminates adhesive-bonded with epoxy resin, because of their thermal conductivity (about λ=0.18-0.25 W/(m·K)). Some of the known fire-protection sheets are also approved for application under direct weathering, i.e., outdoor, but have a high water absorption (about 0.5 g/cm³) because of the highly absorptive lightweight aggregates. Gypsum-based fire-protection sheets are not suitable for outdoor use.

The fire-protection sheets of aerogel concrete according to the invention have a significantly reduced thermal conductivity (about λ=0.06-0.17 W/(m·K)) as compared to sheets made of lightweight concrete. In fire experiments, components of aerogel concrete demonstrated their excellent fire protection properties. The temperatures on the backside of the components are lower by a factor of 2 to 3 as compared to lightweight concrete components. In addition, aerogels are hydrophobic at normal ambient temperatures, so that a considerably lower water absorption is expected for aerogel concrete (about 0.1 g/cm³) as compared to lightweight concrete. At high temperatures (for example, in the event of a fire), the aerogels lose their hydrophobic property and show a hydrophilic behavior. Then, the extinguishing water employed is absorbed by the boards and leads to additional cooling of the boards. As compared to lightweight concrete, aerogel concrete has higher compressive strengths for the same thermal conductivity. The tensile strength can be improved by the addition of glass fibers, and adjusted to individual needs.

An essential further element of the invention is to combine the known fire protecting advantages of aerogel concrete with the field of application of conventional fire protection boards. This possible application results from the improved mechanical properties of the above mentioned high performance aerogel concrete, since previously prepared aerogel concretes have too low compressive and tensile strengths.

Because of their particular properties, fire protection boards of aerogel concrete can be prepared at a lower thickness than that of comparable lightweight concrete boards with the same performance (weight saving, manageability). The preparation of fire protection boards with larger thicknesses that exceed the properties of conventional boards is also possible. Because of the considerably reduced temperatures on the backside of the boards, aerogel concrete fire protection boards can also be employed in critical areas, such as in the fire protection of CFRP strips, where low temperatures must be ensured also in the event of a fire because of the low glass transition temperatures of the epoxy resin employed. Because of the described hydrophobic behavior, the boards are excellently suitable for outdoor use, such as in the fire protection of bridges and civil engineering structures, which are reinforced, for example, with adhesive-bonded CFRP strips or steel plates.

Similar to construction elements made of lightweight or normal concrete, components of aerogel concrete have a high compressive strength in relation to the bulk density, but only a (flexural) tensile strength that is lower by a factor of 5 to 10. Therefore, for the use as flexurally strained components, reinforcement in the aerogel components that absorbs the systematically occurring tensile forces from flexion or central tension is to be ordered, like with steel-reinforced concrete. Previously prepared aerogel concretes have not been suitable for being employed as a reinforced aerogel concrete in flexurally strained components because of their low compressive strength and, in particular, the low bond stress. In addition, only the use of conventional steel reinforcement has been examined to date. The high performance aerogel concrete according to the invention has significantly improved bonding properties and therefore can be employed as a reinforced aerogel concrete. According to the invention, reinforcing elements of glass fiber reinforced plastics are used for this purpose.

To date, aerogel concrete has been optimized mainly in view of its compressive strength and thermal conductivity. The tensile strengths of such aerogel concretes are too low for use in flexurally strained components. Therefore, experiments relating to both the use of glass fibers, which were added to the aerogel concrete during the mixing process, and the bonding behavior of conventional reinforcements of steel-reinforced concrete were performed in aerogel concrete. The use of glass fibers resulted in an improvement of the cracking behavior and an increase of tensile strength. However, an increase of tensile strength to an extent that would enable the use in flexurally strained components has not been documented to date. The known pull-out tests with steel-reinforced concrete show that the bonding behavior of reinforcing steel in aerogel concrete is only moderate. It has been found that the bonding stresses are relatively low, and that the bonding is effected essentially through adhesion. This is in contrast to the supporting performance of steel-reinforced concrete components, where the adhesion component is almost unimportant to the bonding, and the bonding is effected predominantly through friction (smooth reinforcing steel) or mechanical interlock (ribbed reinforcing steel). The use of reinforcing steel as a reinforcement for aerogel concrete components is to be doubted a lot before the background of these results. This is true, in particular, because another elementary requirement for the functioning of the composite material “reinforced aerogel concrete” is not met when reinforcing steel is used: the requirement that the components employed have the same thermal expansion. Conventional concrete has a coefficient of thermal expansion of about 10×10⁻⁶ K⁻¹, reinforcing steel has also 10×10⁻⁶ K⁻¹, and aerogel concrete has about 5×10⁻⁶ K⁻¹. Thus, the thermal expansion of reinforcing steel is about twice that of aerogel concrete, so that temperature loads will lead to different expansions between the aerogel concrete and the reinforcing steel, which is accompanied by a loss of adhesion. In this case, the functionality of the “steel-reinforced aerogel concrete” is irreversibly lost.

Another essential element of the invention is to replace the previously used steel reinforcement by a reinforcement of glass fiber reinforced plastic. This reinforcement is commercially available, but has been employed exclusively in normal concrete or conventional lightweight concrete to date. Studies of the bonding behavior between high performance aerogel concrete and the reinforcement by glass fiber reinforced plastic according to the invention have shown that the bonding stresses are up to f_{b}=3 MPa and thus significantly above the values previously determined for aerogel concrete with steel reinforcement and, in addition, within the range of values of conventional steel-reinforced concrete. Thus, the high performance aerogel concrete according to the invention enables the preparation of aerogel concrete components with reinforcement by glass fiber reinforced plastic. In addition, a reinforcement by glass fiber reinforced plastic with a coefficient of thermal expansion of 6×10⁻⁶K⁻¹ is significantly more suitable for use in aerogel concrete as compared to reinforcing steel. Since aerogel concrete components are employed almost exclusively in fields in which high demands are made on heat protection, the use of a reinforcement by glass fiber reinforced plastic proves particularly advantageous in this respect too: The thermal conductivity of glass fiber reinforced plastic is 0.7 W/(m·K) and thus lower than the thermal conductivity of steel-reinforced concrete by a factor of 85. Since a reinforcement by glass fiber reinforced plastic, unlike reinforcing steel, makes no demands on an alkaline medium, smaller concrete coverages and thus a better utilization of the cross-section are possible.

In the preparation of the thermal shell of residential and non-residential buildings, penetrations of such a shell are unavoidable. Thus, thermal bridges are formed, for example, in balconies made of steel-reinforced concrete cantilever plates, which must necessarily be connected with the floor slabs of the building for static reasons (case a)). Other geometric thermal bridges may occur at the base point of massive walls and supports that stand on non-insulated/unheated floor slabs or cellar ceilings (case b)). The component of high performance aerogel concrete according to the invention serves for the thermal separation of such constructions while at the same time the structural stability is guaranteed.

To date, components consisting of an insulating element, a tensile reinforcement and pressure bearings have been employed for the thermal separation of reinforced steel slabs. The insulating elements are prepared from rock wool or polystyrene rigid foam and cannot adopt a supporting function by themselves. Reinforcing elements of reinforcing steel, stainless steel or glass fibers are employed for the transfer of tensile forces from bending moments and transversal forces. The transfer of compression forces from bending moments and transversal forces is effected through thrust bearings made of construction steel, or high strength mortars. The equivalent thermal conductivities (i.e., the thermal conductivities calculated from the thermal conductivities of the individual components) of such components are within a range of 0.06≤λ≤0.25 W/(m·K). For the thermal separation of wallings with a high bulk density (e.g., sand-lime brick masonry), masonry blocks are employed whose thermal conductivity is reduced below that of sand-lime bricks by the use of lightweight aggregates. Usual strengths of such “insulation bricks” in connection with mortar group IIa are within a range of 6.0≤fₖ≤8.1 MPa, and the thermal conductivity is about λ=0.35 W/(m·K). Heat insulation masonry (for example, made of aerated concrete, lightweight concrete or bricks) cannot be employed here because of its significantly lower compressive strengths.

In both types of components, there is the difficulty of ensuring the negatively correlating properties “high compressive strength” and “low thermal conductivity” at the same time. In case a), this affects the pressure bearings, in particular: While the insulating element has a thermal conductivity of about λ=0.03 to 0.035 W/(m·K), the thermal conductivity of the pressure elements of the prior art obtained from high strength mortars is about λ=0.80 W/(m·K). In addition to the high thermal conductivity of the tension rods, these point thermal bridges are the cause of the fact that the equivalent thermal conductivity of the component exceeds the thermal conductivity of the insulating element by a factor of 2 to 7. A reduction of the thermal conductivity of the pressure elements by using aerogel concrete has not been technically possible to date because of the required compressive strengths. In case b), this holds for the whole component. In case a), there is an additional problem of fire protection if combustible materials (polystyrene rigid foam) are used as an insulating material.

The high performance aerogel concrete according to the invention has a significantly more favorable ratio of compressive strength to thermal conductivity (λ≤0.26 W/(m·K) with a mean compressive strength of f_{cm}=25 MPa).

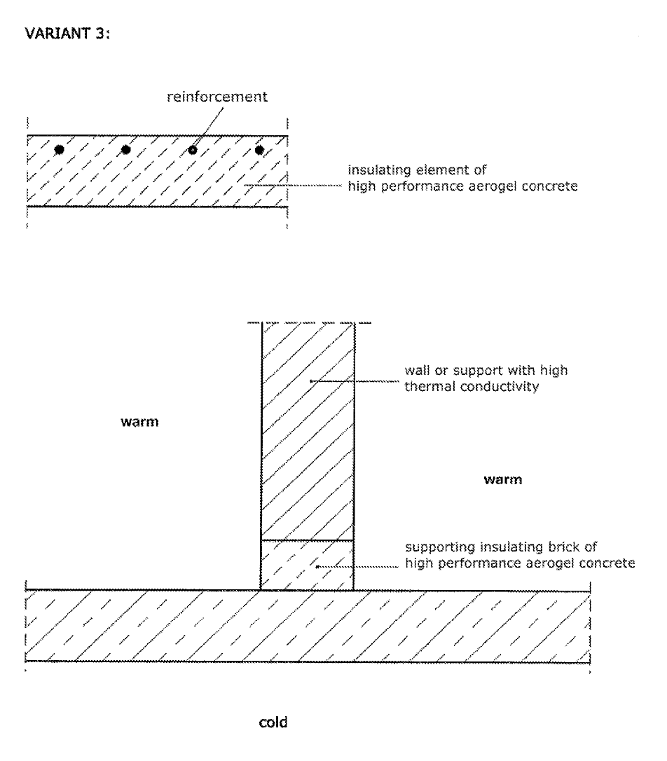

Another essential element of the invention is to prepare the pressure bearings or parts of the component or the whole component from aerogel concrete in case a), and to prepare the entire component from aerogel concrete in case b) (FIGS. 5a, 5b, 5c, 5d, and 5e). In this way, the thermal conductivity of the components is significantly reduced (e.g., by a factor of 2 in case b)) while the required compressive strengths are ensured. In case a), reinforcing steel, stainless steel or glass fiber reinforced plastic is used for tensile reinforcement. By the use of reinforcement by glass fiber reinforced plastic, the equivalent thermal conductivity can be reduced further as compared to other tensile reinforcements.

1. An aerogel concrete mixture containing:
from 10 to 85% by volume/m³ of aerogel granules having a grain size within a range of from 0.01 to 4 mm,
from 100 to 900 kg/m³ of inorganic hydraulic binder,
from 10 to 40% by weight, based on the content of binder, of at least one silica gel suspension,
from 1 to 5% by weight, based on the content of binder, of at least one plasticizer,
from 0.2 to 1% by weight, based on the content of binder, of at least one stabilizer, and
from 0 to 60% by volume/m³ of at least one lightweight aggregate.

2. The aerogel concrete mixture according to claim 1, characterized by containing from 60 to 65% by volume of aerogel granules.

3. The aerogel concrete mixture according to claim 1, characterized in that said aerogel granules have a grain size within a range of from 1 to 4 mm.

4. The aerogel concrete mixture according to claim 1, characterized by comprising from 500 to 550 kg/m³ of inorganic hydraulic binder.

5. The aerogel concrete mixture according to claim 1, characterized in that said inorganic hydraulic binder includes cement, especially Portland cement.

6. The aerogel concrete mixture according to claim 1, characterized in that said silica gel suspension contains from 1 to 60% by volume, especially 50% by volume, of active substance (solids content).

7. The aerogel concrete mixture according to claim 1, characterized by having a w/b ratio of from 0.20 to 0.60, especially from 0.28 to 0.35.

8. A process for preparing a aerogel concrete with the aerogel concrete mixture according to claim 1, characterized in that at first the aerogel and optionally lightweight aggregates are mixed, then a water-silica mixture, a water-plasticizer mixture and the stabilizer are added, in a mixing break the inorganic binder is added, and after renewed mixing, the remaining water is added, mixing further.

9. The process according to claim 8, characterized in that after a mixing time of 30 to 60 seconds each, a water-silica mixture, a water-plasticizer mixture and the stabilizer are added, in a mixing break the inorganic binder is added, and after renewed mixing, especially for 1-2 minutes, the remaining water is added, mixing for another 2-10 minutes.

10. The process according to claim 8, characterized in that the water to be added is cooled down to a temperature of less than 10° C.

11. The process according to claim 8, wherein the concrete is reinforced with a reinforcement of glass fiber reinforced plastic (GFRP), in-situ concretes, precast concrete parts, screeds, precast screed parts, fire protection boards, components for the thermal separation of projecting (steel-reinforced) concrete slabs and walls (wall insulation elements for projecting components) or bricks.

12. The process according to claim 8, wherein the in-situ concrete or precast concrete characterized by comprising a support layer and a supporting heat insulation layer.
